(19) United States
(12) Patent Application Publication
(10) Pub. No.: US 2020/0328686 A1
(43) Pub. Date: Oct. 15, 2020

(54) UNIVERSAL SERIAL BUS TYPE-C CONNECTION INTERFACE

(71) Applicant: STMicroelectronics (Grenoble 2) SAS, Grenoble (FR)

(72) Inventors: Jean CAMIOLO, St Egrêve (FR); Christophe LORIN, Montbonnot (FR)

(21) Appl. No.: 16/839,946

(22) Filed: Apr. 3, 2020

(30) Foreign Application Priority Data
Apr. 12, 2019 (FR) 1903930

(51) Int. Cl. H02M 3/335; H02J 7/00

(52) U.S. Cl. CPC H02M 3/33523; H02J 2207/20; H02J 7/0045

(57) ABSTRACT

Provided is a method implemented in a USB-C supply interface connected between a supply source and a USB-C connector coupled to a load. A comparison is performed between at least one signal representative of an operation of a voltage converter belonging to the interface and at least one threshold. A command module belonging to the interface emits an activation signal to control electrical isolation between the source and the converter. Isolation is implemented by a disconnection device connected between the source and the converter. The disconnection device irreversibly electrically isolates the converter from the source when the activation signal is emitted. The present description also relates to a USB-C supply interface configured to implement such a method.

### BACKGROUND

### Technical Field

The present disclosure generally relates to devices for supplying, from a power supply source, power to a load. The disclosure more particularly relates to a supply interface connected between a source of power and a connector of the USB-C type, the connector being intended to be electrically coupled to a load to be supplied, in particular by a cable of the USB-C type.

### Description of the Related Art

Although today, wireless technology is one of the major areas for research in the field of energy and data exchange, cables still appear to be the most reliable method of connecting several electronic devices, whether to exchange data or to supply or recharge one or more electronic devices.

Among the different types of cables and connectors of the Universal Serial Bus (USB) standard, the USB-C type is one of the types that allows the exchange of data and energy. The USB-PD (Power Delivery) technology is a technology that adapts to cables and connectors of the USB-C type. This technology makes it possible to manage the supply of electronic devices.

### BRIEF SUMMARY

It would be desirable to be able to improve, at least partially, certain aspects of connection interfaces between a source of power and a connector intended to be coupled to a load to be supplied by means of a cable.

More particularly, it would be desirable to be able to improve, at least partially, certain aspects of connection interfaces between a source of power and a connector of the USB-C type, preferably adapted to the USB-PD technology, intended to be coupled to a load to be supplied by means of a USB-C cable, preferably adapted to the USB-PD technology.

One embodiment addresses all or some of the drawbacks of the known connection interfaces between a source of power and a connector intended to be coupled to a load to be supplied, in particular in the case of a connector of the USB-C type, preferably adapted to the USB-PD technology.

One embodiment provides a method implemented in a USB-C supply interface connected between a supply source and a USB-C connector coupled to a load to be supplied, in which, based on a comparison of at least one signal representative of an operation of a voltage converter belonging to the interface, to at least one threshold, a command module belonging to the interface emits an activation signal to control electrical isolation between said source and said converter, the isolation being implemented by a disconnection device connected between said source and said converter, said device belonging to the interface and electrically isolating the converter from said source in an irreversible manner when the activation signal is emitted.

According to one embodiment, the converter is configured to supply a second DC voltage from a first voltage supplied by the source.

According to one embodiment, the signal or signals representative of the operation of the converter is or are chosen from among a first signal representative of the temperature in the interface, a second signal representative of the second voltage and/or a third signal representative of a voltage internal to the converter.

According to one embodiment, said module emits the activation signal when the temperature of the interface is above a maximum temperature beyond which the converter is considered to be defective, a comparison of the first signal to a threshold representative of the maximum temperature indicating whether the temperature of the interface is above the maximum temperature.

According to one embodiment, said module emits the activation signal when the second voltage is above a maximum voltage beyond which the converter is considered to be defective, a comparison of the second signal to a threshold representative of said maximum voltage indicating whether the second voltage is above the maximum voltage.

According to one embodiment, the converter is controlled by said module to supply the second voltage at a setpoint value, preferably selected from among a plurality of predefined setpoint values.

According to one embodiment, while the smallest of said plurality of predefined setpoint values is selected, said module transmits the activation signal when the second voltage is below a minimum voltage below which the converter is considered to be defective, a comparison of the second signal to a threshold representative of the minimum voltage indicating whether the second voltage is below the minimum voltage.

According to one embodiment: said plurality of predefined setpoint values are selected successively; said module transmits the activation signal if, for each of said plurality of selected setpoint values, the second voltage is above a threshold value determined by the selected setpoint value; and for each of the plurality of selected setpoint values, a comparison of the second signal to a threshold representative of said threshold voltage indicates whether the second threshold is above said threshold voltage.

According to one embodiment, each comparison of the second signal is done while a switch of the interface coupling the converter to said connector is open.

According to one embodiment, the first signal is supplied by a temperature sensor of the interface.

One embodiment provides a USB-C supply interface intended to be connected between a supply source and a USB-C connector coupled to a load to be supplied, configured to implement the method defined above.

According to one embodiment, the converter is a switched-mode power supply of the buck-boost type comprising a galvanic isolation between the first terminals of the converter intended to receive the first voltage and the second terminals of the converter intended to supply the second voltage.

According to one embodiment, the interface comprises at least one comparator configured to implement said comparison(s).

According to one embodiment, the interface comprises a galvanic isolation device configured to send the disconnection device the activation signal transmitted by the command module, the galvanic isolation device preferably being an optocoupler, the optocoupler preferably being configured, when it sends said activation signal, to circulate a current in a heating device of the disconnection device in order to cause an opening of a fuse of the disconnection device.

### BRIEF DESCRIPTION OF THE SEVERAL VIEWS OF THE DRAWINGS

The foregoing features and advantages, as well as others, will be described in detail in the following description of specific embodiments given by way of illustration and not limitation with reference to the accompanying drawings, in which:

FIG. 1 is a schematic view illustrating a connection between a supply source and a load to be supplied;

FIG. 2 schematically shows one embodiment of a circuit of a connection interface of the USB-C type adapted to the USB-PD technology;

FIG. 3 shows, very schematically and in block form, an embodiment of a method implemented in an interface of the type of that of FIG. 2;

FIG. 4 shows, very schematically and in block form, a more detailed embodiment of the method of FIG. 3;

FIG. 5 shows, very schematically and in block form, another more detailed embodiment of the method of FIG. 3;

FIG. 6 shows, very schematically and in block form, another more detailed embodiment of the method of FIG. 3;

FIG. 7 shows, very schematically and in block form, another more detailed embodiment of the method of FIG. 3; and

FIG. 8 schematically shows a more detailed embodiment of the circuit of the connection interface of FIG. 2.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, the management of the negotiation phase regarding the supply power to be supplied to a load from a supply source is not described in detail. Furthermore, only the relevant aspects of the USB-C and USB-PD technologies are described, the other aspects adapting themselves unchanged. In particular, the data exchange function via connectors, and if applicable a cable of the USB-C type, preferably adapted to the USB-PD technology, is not described, the described embodiments being compatible with the standard data exchange function of the USB-C and USB-PD technologies.

Unless indicated otherwise, when reference is made to two elements connected together, this signifies a direct connection without any intermediate elements other than conductors, and when reference is made to two elements linked or coupled together, this signifies that these two elements can be connected or they can be linked or coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless otherwise specified, the expressions “about”, “approximately”, “substantially” and “on the order of” mean to within 10%, preferably to within 5%.

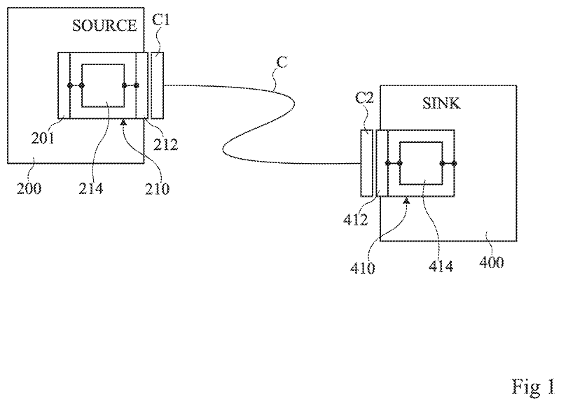

FIG. 1 is a schematic view illustrating an energy transmission between a device 200 serving as supply source (SOURCE) and an electronic device, or load, to be supplied 400 playing the role of a load (SINK). The devices 200 and 400 are connected by means of a cable C of the USB-C type, in this example adapted to the USB-PD or USB “POWER DELIVERY” technology.

The supply device 200 comprises a source of an electrical supply power 201. The source 201 can be the electrical distribution grid, i.e., the mains, which delivers an alternating voltage. The source 201 can also be a source of a DC voltage, for example the end of an Ethernet cable implementing a power supply function (“Power On Ethernet”-POE), for example making it possible to deliver a DC voltage of about 57 or 58 V. More generally, the device 200 can be a computer, a portable battery, etc., or any other electronic device configured to power a device and/or recharge a battery.

The cable C comprises, at each of its ends, a connector C1, C2 of the USB-C type, in this example adapted to the USB-PD technology. The connectors C1, C2 are generally identical.

A coupling element 210, respectively 410, comprising a connection interface 214, respectively 414, and a connector 212, respectively 412, is arranged on the side of the device 200, respectively of the device 400. The interface 214, respectively 414, couples the source 201, respectively the load 400, to the connector 212, respectively 412. Preferably, it is considered that the coupling elements 210, respectively 410, are part of the supply device 200, respectively of the load 400. Each connector 212, 412 is configured to cooperate with a connector C1, C2 of the cable C. The interfaces 214, 414 are generally identical. The connection interfaces 214, 414 allow the supply power supplied by the supply source 201 to be adapted as a function of the supply power supplied to the load 400. Preferably, the connection interfaces 214, 414 allow the supply power supplied by the supply source 201 to be adapted as a function of a supply power requested by the device 400, in particular in the case where the USB-PD technology is implemented. More particularly, the interface 214 comprises a power converter (not shown in FIG. 1), preferably a DC/DC or AC/DC voltage converter, controlled to adapt, from the supply source 201, the power supplied to the load 400.

During a connection, for example managed by the USB-PD technology, communication is established between the devices 200 and 400 to decide on the electrical supply power necessary for the device 400 in order to be able to be supplied and/or recharged. More particularly, the device 400 indicates, for example via its interface 414, the minimum power required for its operation and the device 200 indicates, for example via its interface 214, the supply powers that it is capable of supplying. A negotiation, in this example managed by the USB-PD technology, then begins to define what power the device 200 will supply to the device 400. Once this negotiation is complete, the connection interface 214 adapts the supply power from the supply source 201 according to the result of the negotiation, then the supply of the device 400 begins. The interface 214 then controls its voltage converter according to the result of the negotiation, in order to adapt the power of the supply source 201 to the negotiated power.

As an example, the supply powers that the device 200 is capable of supplying are selected from among a list of predefined supply powers, the list for example being stored in the interface 214. Preferably, this list is predefined, for example by a standard. Each supply power of this list is characterized by a plurality of values, in particular by the value of the voltage corresponding to this power. In the USB-PD technology, each set of values characterizing a predefined supply power corresponds to a set of information designated by the acronym PDO (“Power Data Object”), which can be transmitted between devices 200 and 400 adapted to the USB-PD technology in order to define, during a negotiation, the power that the device 200 delivers to the load 400.

The converter of the interface 214 can, however, be defective, for example due to an operating defect of the capacitors (not shown) that it comprises and/or an operating defect of a control or feedback loop (not shown) of the converter. Such a malfunction can cause a risk for a user, in particular because the device 200, and in particular its interface 214, can then reach high temperatures, for example above 100° C., or even explode or ignite subsequent to the temperature increase. This is particularly problematic when the coupling element 210, for example a wall outlet, is permanently attached to the supply source 201, in particular due to the fact that the electrical connection between the interface 214 and the supply source 201 is not directly accessible to the user, for example due to the fact that the source 201 is arranged in a wall. Indeed, in this case, even if the user notices an operating defect of the interface 214, the user does not have an easy solution to stop the electrical supply of the converter of the interface 214 and avoid the risks related to the malfunction of the interface 214.

Thus, in the described embodiments, it is provided to detect a malfunction of the converter of the interface 214, and to electrically, and definitively, isolate the interface 214 and its converter from the supply source 201 when such a malfunction is detected.

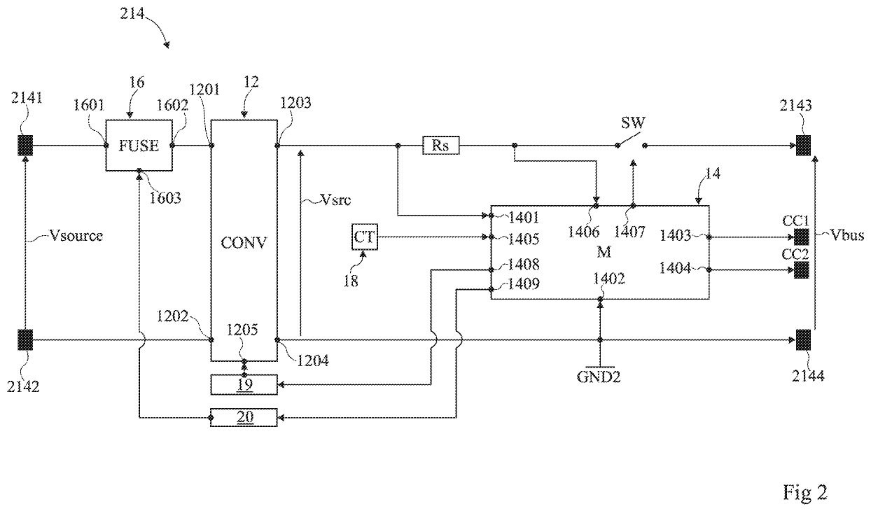

FIG. 2 schematically shows an embodiment of a circuit of a connection interface 214 of the USB-C type, in this example adapted to the USB-PD technology. Generally, the interfaces 214 and 414 (FIG. 1) are identical. However, the provision of a permanent disconnection between a supply source 201 and the converter of the interface is only active in the interface of the device serving as supply source. In this example, the provision of a permanent disconnection between a supply source 201 and the converter of an interface is active in the interface 214. Thus, although the interface 214 is described below, what is indicated may apply to the interface 414.

The interface 214 comprises at least two input terminals 2141, 2142 connected to the supply source 201 (not shown), for example mains. A voltage Vsource of the supply source 201 is applied across the terminals 2141 and 2142, the voltage Vsource for example being referenced relative to the potential of the input terminal 2142. The interface 214 further comprises a first output terminal 2143 supplying a supply voltage Vbus, referenced relative to a reference potential GND2 received by a second output terminal 2144, and at least one communication terminal. These output terminals are all intended to be coupled to the connector 212 (not shown), which then allows the coupling with the device 400, for example via the connector C1, the cable C and the connector C2, as shown in FIG. 1. In this embodiment, the interface 214 comprises two communication terminals CC1, CC2. One advantage of having two communication terminals is that, if these terminals are positioned symmetrically on the connector 212, this makes it possible to manufacture a reversible connector C1, which is to say, a connector C1, for example with a rectangular shape, that can be coupled to the connector 212 in a first direction and in a second direction opposite to the first.

The interface 214 comprises a converter (CONV) 12, a switch SW, a control module or circuit (M) 14, and an electrical disconnection device or circuit (FUSE) 16, the device 16 being controllable by means of a signal generated by the command module 14. In the described embodiment, the interface 214 further comprises a temperature sensor (CT) 18. Preferably, the sensor 18 is an integrated sensor belonging to the integrated circuit of the interface 214.

The converter 12 is for example a switched-mode power supply suitable for converting the voltage Vsource into a DC supply voltage Vsrc.

Preferably, when the voltage Vsource is an AC voltage, for example the mains voltage, the converter comprises a rectifier bridge, for example a diode bridge, and a filter, for example a capacitor, in order to obtain an intermediate DC voltage from which the voltage Vsrc is generated. As an example, the voltage Vsrc can be lower or higher than the voltage Vsource when the latter is a DC voltage, or the DC intermediate voltage available at the output of the rectifier bridge of the converter when the voltage Vsource is an AC voltage, the converter then being of buck-boost type.

Preferably, the converter 12 further comprises a galvanic isolation between the input terminals 1201, 1202 of the converter intended to receive the voltage Vsource, and the output terminals 1203 and 1204 of the converter intended to supply the DC voltage Vsrc. As an example, it is considered here that the converter 12 is a buck-boost converter provided with a galvanic isolation and a rectifier bridge, the converter then commonly being called “flyback” converter.

The converter 12 comprises:
the input terminal 1201 intended to receive the voltage Vsource, therefore to be coupled to the terminal 2141;
the input terminal 1202 intended to receive the reference potential of the voltage Vsource, therefore to be coupled to the terminal 2142;
the output terminal 1203 supplying the converted or adapted voltage Vsrc;
the output terminal 1204 at the reference potential GND2; and
a control terminal 1205 receiving a command signal representative of a setpoint value of the voltage Vsrc.

The disconnection device 16 is connected between the supply source supplying the voltage Vsource and the converter 12, that is to say, between the terminals 2141, 2142 and the terminals 1201, 1202. In this example, the device 16 comprises a terminal 1601 connected to the terminal 2141, a terminal 1602 connected to the terminal 1201, and a control terminal 1603 receiving an activation signal sent by the module 14. When the device 16 is activated by the module 14, its activation is irreversible and results in an electrical isolation between the converter 12 and the voltage source Vsource, or in other words, in a disconnection of the converter 12 and the source of the voltage Vsource. More particularly, in this example, the activation of the device 16 causes the disconnection of the terminal 2141 from the terminal 1201. Preferably, the device 16 comprises a fuse, for example a fuse in which the conduction can be interrupted permanently when the fuse is heated past a given temperature, and a heating element able to be activated by the activation signal supplied by the module 16.

One of the terminals of the switch SW is connected to the terminal 1203 of the converter 12, its other terminal being connected to the output terminal 2143 supplying the voltage Vbus. In this embodiment, the switch SW is commanded, or controlled, by the control module 14. When the switch SW is open, the output terminal 1203 of the converter is electrically isolated from the output terminal 2143 of the interface, or in other words, the converter 12 is electrically isolated from any load 400 coupled to the interface 214.

The control module 14 here is supplied by the voltage Vsrc. Thus, the module 14 comprises a terminal 1401 coupled, preferably connected, to the terminal 1203 of the converter 12, and a terminal 1402 coupled, preferably connected, to the terminal 1204 of the converter 12. The module 14 further comprises one or more communication terminals coupled, preferably connected, to the communication terminal(s) of the interface 214. In this example, the module 14 comprises two terminals 1403, 1404, connected to the respective terminals CC1 and CC2.

The module 14 is configured to observe one or more signals representative of the operation of the interface 214, and in particular its converter 12. The module is further configured to detect a malfunction of the interface 214, and in particular of its converter 12, by comparing the signals representative of the operation of the interface to thresholds. The module 14 is configured to control the activation of the disconnection device 16, by sending an activation signal to the device 16, when it detects such a malfunction.

The signal(s) representative of the operation of the interface 214, and in particular of the converter 12, are for example a signal representative of the temperature in the interface, a signal representative of the voltage Vsrc, for example the voltage Vsrc itself, a signal representative of a current supplied by the converter 12 and/or a signal representative of a voltage internal to the converter 12, for example a DC internal voltage intended to supply a command circuit, or control circuit, of a chopper switch of the converter, this internal voltage for example being obtained from the voltage Vsource.

Thus, the module 14 comprises input terminals intended to receive the signal(s) representative of the operation of the interface 214 that the module 14 observes.

In this embodiment, the voltage Vsrc is observed directly by the module 14, by means of its terminal 1401. In an alternative embodiment, the module 14 can comprise an additional input terminal dedicated to the reception of a signal representative of the voltage Vsrc.

Furthermore, in this embodiment, the module 14 receives, from the temperature sensor 18, a signal representative of the temperature measured by the sensor, that is to say, the temperature in the interface. The module 14 then comprises a terminal 1405 coupled, preferably connected, to the sensor 18 in order to receive this signal. In one alternative embodiment, where the interface 214 does not comprise the sensor 18, the terminal 1405 can be omitted. In another alternative embodiment, a plurality of temperature sensors 18 can be provided, and the module 14 then preferably comprises as many terminals 1405 as there are sensors 18.

Furthermore, in this embodiment, the module comprises an input terminal 1406 configured to receive a signal representative of the current supplied by the converter 12, and more specifically by the terminal 1203 of the converter. The terminal 1406 here is coupled, preferably connected, to a terminal of a resistance Rs coupled, preferably connected, to the terminal of the switch SW opposite the terminal 2143, the other terminal of the resistance Rs being coupled, preferably connected, to the terminal 1203 of the converter 12 and to the terminal 1401 of the module 14. The voltage across the terminals of the resistance Rs is representative of the current supplied by the converter 12.

In this embodiment, the module 14 is configured to control the switch SW. The module 14 then comprises a control terminal 1407 supplying a control signal to the switch SW.

In this embodiment, the module 14 is configured to control the converter 12, i.e., to supply the converter 12 with a signal representative of a setpoint value of the voltage Vsrc at the terminal 1205 of the converter 12. The module 14 then comprises a control terminal 1408 supplying the signal representative of a setpoint value of the voltage Vsrc. Preferably, the signal representative of the setpoint value of the voltage Vsrc is determined from a deviation between the voltage Vsrc delivered by the converter 12 and the setpoint value of the voltage Vsrc. As an example, the setpoint value of the voltage Vsrc is determined by the power negotiated between the devices 200 and 400 (FIG. 1).

In this example where the converter 12 is provided with a galvanic isolation, the signal representative of the setpoint value of the voltage Vsrc is sent to the terminal 1205 by means of a galvanic isolation device 19, preferably an optocoupler. The device 19 is connected between the terminal 1408 and the terminal 1205.

The module 14 also comprises a control, or activation, terminal 1409. The terminal 1409 supplies the activation signal to the terminal 1603 of the disconnection device 16.

In this example where the converter 12 is provided with a galvanic isolation, the activation signal is sent to the terminal 1603 by means of a galvanic isolation device 20, preferably an optocoupler. The device 20 is connected between the terminal 1409 and the terminal 1603.

Although an embodiment has been described here in which the module 14 controls the converter 12, the switch SW and the device 16, and compares the signal(s) representative of the operation of the interface 214, in alternative embodiments, these functions can be implemented by a plurality of distinct control modules or circuits.

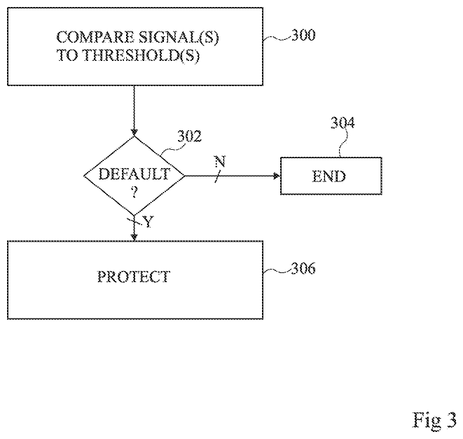

FIG. 3 shows, very schematically and in block form, an embodiment of a method implemented in an interface of the type of that of FIG. 2.

In a step 300 (“COMPARE SIGNAL(S) TO THRESHOLD(S)” block), one or more signals representative of the operation of the interface 214, and in particular its converter 12, are compared to corresponding thresholds. As an example, one or more thresholds can be associated with each signal. In this example, it is considered that this or these comparisons are implemented by the module 14, which receives, or observes, the signal(s) representative of the operation of the converter 12. Thus, the module 14 comprises one or more comparators configured to implement this or these comparisons. Furthermore, step 300 can be implemented continuously, that is to say, a signal representative of the operation of the converter 12 is continuously compared to one or more thresholds that are associated with it, the result of this comparison being able to be taken into account only at certain moments, for example periodically.

In the following step 302 (“DEFAULT?” block), from the result of the comparison(s) done in step 300, it is determined whether the converter 12 is considered to be defective, or in other words, whether the converter 12 suffers from an operating defect. For example, if a signal representative of the operation of the converter 12 exceeds a threshold associated with it, this may mean that the converter 12 is defective. In this example, this step is implemented by the module 14.

If the converter 12 is not considered to be defective (output N of the block 302), the method continues to a step 304 (“END” block) marking the end of the method. In a variant, the method can continue by a new implementation of the step 300.

Conversely, if the converter 12 is considered to be defective (output Y of the block 302), the method continues in a step 306 (“PROTECT” block) during which the disconnection device 16 is activated, in this example following the transmission of an activation signal by the module 14. Once this step 306 is performed, the method can no longer be implemented, in particular due to the fact that the interface 214 and its module 14 are no longer supplied with electricity.

As an example, the module 14 comprises a finite state machine circuit, a microprocessor associated with an instructions memory and/or a dedicated circuit (“ASIC—Application Specific Integrated Circuit”) that are configured to carry out steps 302 and 306 from the result of the comparison(s) done in step 300.

Furthermore, it will be noted that as a function of the signal(s) observed in step 300, the method is preferably implemented while the switch SW is open, for example upon each connection of a load to be supplied 400, each disconnection of the load 400 and/or when no load 400 is connected.

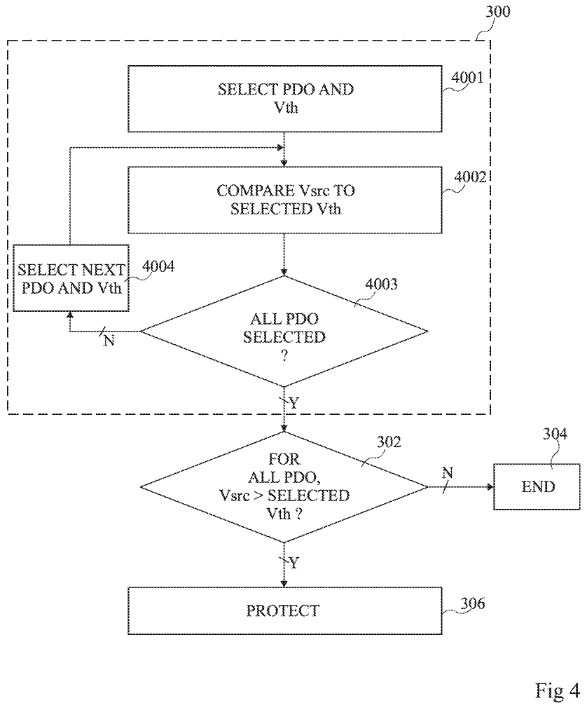

Various more detailed embodiments of the method of FIG. 3 will now be described in connection with FIGS. 4, 5, 6, 7 and 8. These various embodiments can be combined with one another, or in other words, more than one of these embodiments can be implemented by the module 14, simultaneously and/or one after the other.

FIG. 4 shows, schematically and in block form, a more detailed embodiment of the method of FIG. 3. In this embodiment, the signal representative of the operation of the interface 214 and its converter 12 is a signal representative of the voltage Vsrc.

Preferably, the method of FIG. 4 is implemented during a verification phase during which the device 200 determines those of the predefined supply powers that it is actually able to provide to the load 400. As an example, such a verification phase is implemented by controlling the converter 12 so that it supplies different voltage values Vsrc, and observing whether the converter 12 is indeed able to supply these different values of the voltage Vsrc. Such a verification phase makes it possible, during a subsequent phase for negotiating a supply power between the devices 200 and 400, for the device 200 only to propose the predefined supply powers that it is actually able to supply. The method of FIG. 4 then uses steps already provided to implement this verification phase.

Preferably, the method of FIG. 4 is implemented while the switch SW is open, so as to prevent the load 400 from receiving a power for which it is not adapted and which could potentially damage it.

In this embodiment, step 300 comprises a step 4001 (“SELECT PDO AND Vth” block).

In step 4001, a predefined supply power is selected, in this example by the module 14. The selection of one of the predefined supply powers, characterized by a corresponding PDO set, determines a setpoint value of the voltage Vsrc that the converter 12 supplies. In other words, in step 4001, a setpoint value of the voltage Vsrc is selected.

The setpoint value of the voltage Vsrc determines a first threshold value representative of a threshold voltage Vth. It is considered here that the device 200 is not capable of supplying a selected predefined power if, while the converter 12 is controlled accordingly, the voltage Vsrc delivered by the converter is greater than the threshold voltage Vth associated with this selected predefined power. In practice, the comparison of the signal representative of the voltage Vsrc to the first threshold indicates whether the voltage Vsrc is or is not greater than the threshold voltage Vth. For a selected predefined supply power, the corresponding threshold voltage Vth is for example one of the pieces of information making up the PDO set corresponding to this predefined power.

At the end of step 4001, the converter 12 is controlled, in this example by the module 14, to supply the voltage Vsrc at the setpoint value corresponding to the selected predefined power.

In a following step 4002 (“COMPARE Vsrc TO SELECTED Vth”), for the selected predefined power, the signal representative of the voltage Vsrc is compared to the first threshold. The result of the comparison indicates whether the voltage Vsrc is or is not greater than the threshold voltage Vth.

In a following step 4003 (“ALL PDO SELECTED” block), it is verified whether all of the predefined supply powers, in other words all of the corresponding PDO sets, have been tested.

If predefined supply powers remain to be tested (output N of the block 4003), step 300 continues with a step 4004 (“SELECT NEXT PDO AND Vth” block). During step 4004, one of the predefined powers not yet having been tested is selected. This triggers the update of the threshold voltage Vth to which the voltage Vsrc is compared, thus of the first threshold to which the signal representative of the voltage Vsrc is compared. The selection of a predefined power also causes the update of the control of the converter 12.

After step 4004, step 300 continues to step 4002, then step 4003.

When all predefined powers have been selected during corresponding steps 4001 or 4004 (output Y of block 4003), step 300 has been completed. The method then continues with step 302, shown here in the form of a block “FOR ALL PDO, Vsrc>SELECTED Vth?”.

In this embodiment, the step 302 consists in verifying, for each of the setpoint values of the voltage Vsrc selected in step 300, from the corresponding comparison of the signal representative of the voltage Vsrc to the first threshold, whether the voltage Vsrc has exceeded the threshold voltage Vth corresponding to the selected setpoint value. If this is the case, the source 200 cannot supply any of the predefined supply powers and the converter 12 is considered to be defective. The method continues by the activation step 306 of the device 16. Otherwise, the method ends in step 304.

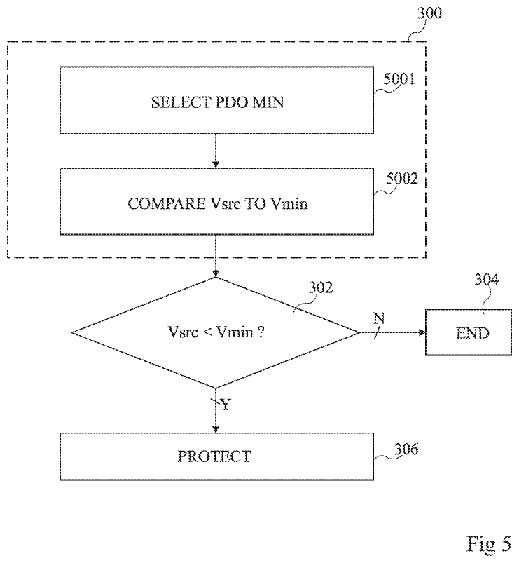

FIG. 5 shows, schematically and in block form, another more detailed embodiment of the method of FIG. 3. In this embodiment, the signal representative of the operation of the interface 214 and its converter 12 is a signal representative of the voltage Vsrc, for example the voltage Vsrc itself.

Preferably, the method of FIG. 5 is implemented while the switch SW is open, so as to prevent the load 400 from receiving a power for which it is not adapted and which could potentially damage it.

In this embodiment, step 300 comprises a step 5001 (“SELECT PDO MIN” block). In step 5001, the smallest of the predefined supply powers is selected. Similarly to what is indicated in connection with steps 4001 and 4004 of FIG. 4, the selection of this supply power amounts to selecting a setpoint value of the voltage Vsrc, for example defined by the PDO set corresponding to the selected predefined power.

Step 300 comprises a step 5002 (“COMPARE Vsrc TO Vmin” block) after step 5001. In this step 5002, a signal representative of the voltage Vsrc is compared to a second threshold representative of a minimum voltage Vmin. The result of the comparison indicates whether the voltage Vsrc is or is not greater than the minimum voltage Vmin. It is considered here that the converter 12 is defective if, while the smallest of the predefined powers is selected, the voltage Vsrc is below the minimum voltage Vmin. As an example, the minimum voltage Vmin is about 4.5 V, for example equal to 4.5 V, for a predefined minimum power corresponding to a voltage Vbus of 5 V.

After step 5002, step 300 is followed by step 302, shown here in the form of a block “Vsrc<Vmin?”. From the comparison of the signal representative of the voltage Vsrc to the second threshold, the module 14 determines whether the voltage Vsrc is or is not greater than the voltage Vmin. If the voltage Vsrc is less than Vmin (output Y of the block 302), the converter 12 is considered to be defective. The method then continues in the activation step 306 of the device 16. Conversely, if the voltage Vsrc is greater than the voltage Vmin (output N of the block 302), the method ends in step 304.

When this method is implemented simultaneously with the method of FIG. 4, step 5001 can be implemented at the same time as step 4001 or 4004, during which the smallest of the predefined powers is selected. Step 5002 can then be implemented simultaneously with the corresponding step 4002, by comparing the signal representative of the voltage Vsrc to the first and second thresholds simultaneously.

The method of FIG. 5 is more particularly adapted to the case where the supply source 201 is stable, that is to say, it delivers substantially the same power to the converter 12, which, when it is operational, can then deliver the smallest of the predefined powers.

In the case where the supply source 201 is not stable, for example when the supply source 201 is a battery whose load state is not known, it is possible to provide that step 300 of the method of FIG. 5 further comprises a step for verifying the power supplied to the converter 12 by the source 201. This additional step allows a verification that the power supplied by the supply source 201 is sufficient for the converter 12, if it is not defective, to supply the smallest predefined supply power. In this case, the implementation of step 306 can be conditioned by the fact that the power supplied to the converter 12 is sufficient for the converter 12 to be able to supply the smallest predefined supply power.

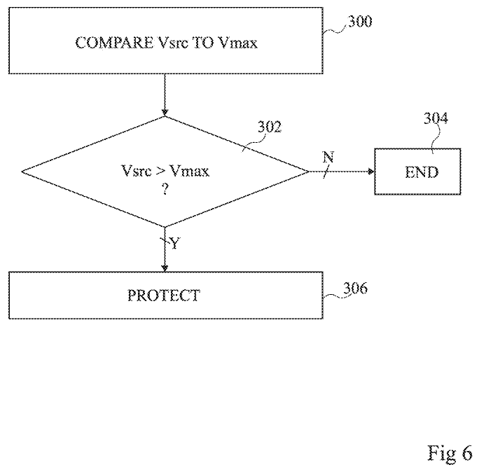

FIG. 6 shows, schematically and in block form, another more detailed embodiment of the method of FIG. 3. In this embodiment, the signal representative of the operation of the interface 214 and its converter 12 is a signal representative of the voltage Vsrc, for example the voltage Vsrc itself.

Preferably, the method of FIG. 6 is implemented while the switch SW is open, so as to prevent the load 400 from receiving a power for which it is not adapted and which could potentially damage it.

In this embodiment, in step 300, shown here in the form of a “COMPARE Vsrc TO Vmax” block, a signal representative of the voltage Vsrc is compared to a third threshold. The third threshold is representative of a maximum threshold. The result of the comparison of the signal representative of the voltage Vsrc to the third indicates whether the voltage Vsrc is or is not greater than the maximum voltage Vmax A in step 302; it is considered here that the converter 12 is defective, for example since its control loop, or feedback loop, is open, if the voltage Vsrc exceeds the maximum voltage Vmax. As an example, the maximum voltage is about 25 V, preferably equal to 25 V.

In the following step 302, shown here in the form of a “Vsrc>Vmax?” block, the module 14 determines, from the comparison of the signal representative of the voltage Vsrc to the third threshold, whether the voltage is or is not greater than the voltage Vmax, or in other words, whether the converter 12 is or is not defective.

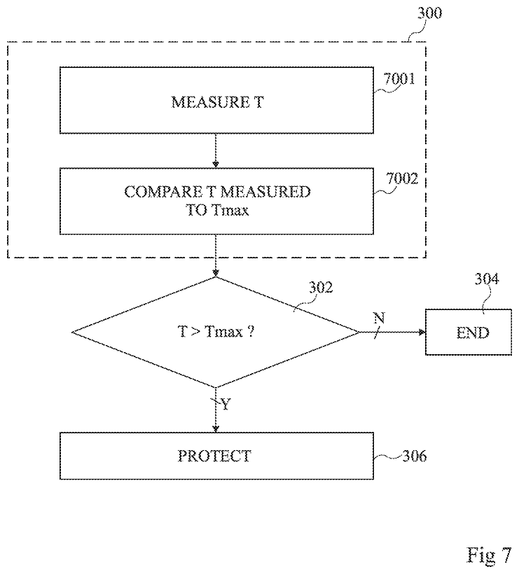

FIG. 7 shows, schematically and in block form, another more detailed embodiment of the method of FIG. 3. In this embodiment, the signal representative of the operation of the interface 214 and its converter 12 is a signal representative of the temperature T of the interface 214, for example the signal supplied by the sensor 18 to the module 14.

Step 300 here comprises a step 7001 (“MEASURE T” block). During step 7001, the temperature T in the interface is measured, for example by the sensor 18. This step provides a signal representative of the measured temperature T, therefore the temperature T of the interface 214.

Step 300 further comprises a step 7002 (“COMPARE T MEASURED TO Tmax” block) after step 7001. Step 7002 consists of comparing the signal representative of the measured temperature T to a fourth threshold representative of a maximum temperature Tmax. The result of this comparison indicates whether the temperature T of the interface is or is not greater than the temperature Tmax. It is considered here that the converter 12 is defective if the temperature T is above the temperature Tmax. Indeed, a temperature increase in the interface can be representative of an increase in losses in the converter 12, this increase in losses reflecting a malfunction of the converter. As an example, the maximum temperature is about 110° C., preferably equal to 110° C.

After step 7002 from step 300, the method continues to step 302, shown here in the form of a block “T>Tmax?”. From the comparison of the signal representative of the temperature T of the interface to the fourth threshold, the module 14 determines whether the temperature T of the interface 214 is higher than the maximum temperature Tmax. If the temperature T is higher than the maximum temperature Tmax (output Y of the block 302), the method continues to step 306 for activation of the device 16. Otherwise (output N of the block 302), the method ends in step 304.

Preferably, the method of FIG. 7 is implemented periodically, whether or not a load 400 is coupled to the supply source 200.

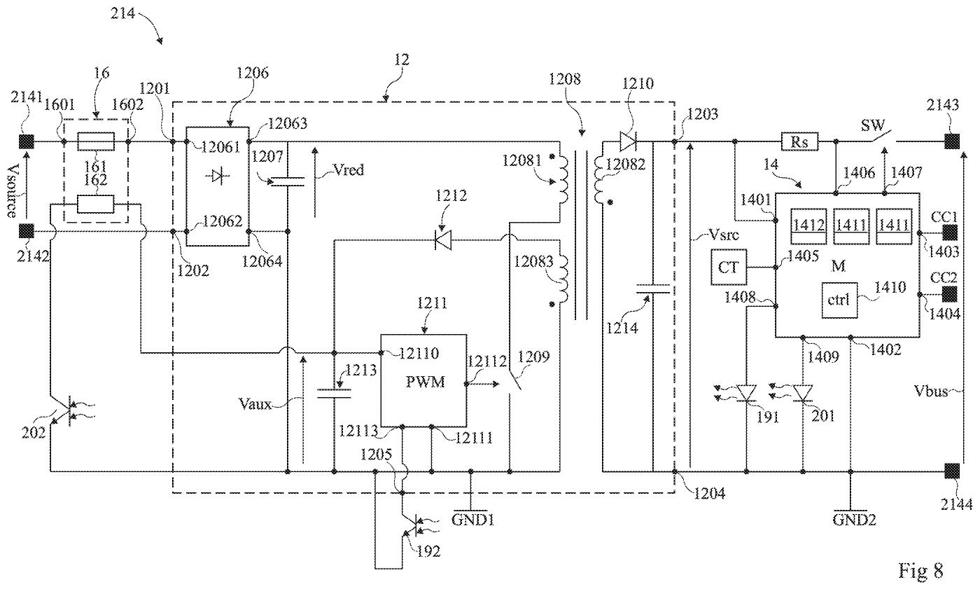

FIG. 8 schematically shows a more detailed embodiment of the circuit of the interface 214 of FIG. 2.

In this embodiment, as an example, the case is considered of a converter 12 of the “flyback” type (buck-boost with galvanic isolation). The converter 12 then comprises a voltage rectifier bridge 1206, typically a diode bridge, shown here in the form of a block. The rectifier bridge 1206 comprises two input terminals 12061 and 12062 that are coupled, preferably connected, to the respective terminals 1201 and 1202 of the converter 12. The bridge 1206 comprises two output terminals 12063 and 12064.

The converter 12 comprises a capacitance 1207 connected across the output terminals 12063 and 12064 of the rectifier bridge 1206. Thus, the bridge 1206 supplies, across the terminals of the capacitance 1207, a voltage Vred internal to the converter 12, referenced at a reference potential GND1 available on the terminal 12064.

The converter 12 comprises a transformer 1208 providing the galvanic isolation between the terminals 1201 and 1202 on the one hand, and the terminals 1203 and 1204 on the other hand. In this embodiment, the transformer 1208 comprises a first primary winding 12081 and a second primary winding 12082. The primary winding 12081 is connected in series with a chopper switch 1209, across the terminals 12063 and 12064. The secondary winding 12082 is connected in series with a diode 1210, across the output terminals 1203 and 1204 of the converter 12. The anode of the diode 1210 here is on the side of the winding 12082.

In this embodiment, the transformer 1208 comprises a second primary winding 12083. The second primary winding 12083 makes it possible here to supply the voltage Vaux internal to the converter 12, the voltage Vaux constituting a supply voltage of a command module or circuit (PWM) 1211 of the switch 1209. More specifically, the second primary winding 12083 has a terminal coupled, preferably connected, to the terminal 12064. A diode 1212 and a capacitance 1213 are connected in series to the other terminal of the second primary winding 12083 and the terminal 12064. The anode of the diode 1212 here is on the side of the second primary winding 12083. The voltage Vaux, for example referenced relative to the reference potential GND1, is available across the terminals of the capacitance 1213.

The command circuit 1211 comprises two terminals 12110 and 12111 configured to receive a supply voltage, here the voltage Vaux, the terminal 12111 being coupled, preferably connected, to the terminal 12064 to receive the reference potential GND1. The circuit 1211 further comprises a terminal 12113 coupled to the terminal 1205 of the converter 12 in order to receive a command signal, or setpoint signal.

The converter 12 comprises a capacitance 1214 connected across the terminals 1203 and 1204.

In this embodiment, the disconnection device 16 comprises a fuse 161. The fuse 161 here can be heat-activated. The fuse 161 is connected across the terminals 2141 and 1201. The device 16 further comprises a heating element 162, typically a resistance. In this embodiment, the activation of the device 16 following the transmission of an activation signal by the module 14, causes a current to pass into the heating element 162, resulting in the fuse 161 opening and definitively isolating the terminal 2141 from the terminal 1201.

In this embodiment, the device 20 (FIG. 2) is an optocoupler. The optocoupler 20 comprises a photodiode 201 connected between the terminal 1409 of the module 14 and the terminal 2144 at the reference potential GND2. The optocoupler 20 further comprises a bipolar transistor 202. The optocoupler 20 operates in an on/off manner. In other words, the transistor 202 is configured so as to be blocked when the photodiode 201 does not emit light, that is to say, when the module 14 does not transmit an activation signal of the device 16, and to be on when the photodiode 201 emits light, that is to say, when the module transmits an activation signal of the device 16 and a current circulates in the photodiode 201. The light emitted by the photodiode 201 is received by the base of the transistor 202. The transistor 202 is connected in series with the resistance 162 of the device 16, the series association of the transistor 202 and the resistance 162 being connected in parallel with the capacitance 1213. Thus, when the module 14 transmits an activation signal of the device 16, the photodiode 201 emits light and the transistor 202 turns on, resulting in a current circulating in the resistance 162 and causing the opening of the fuse 201, here by heating.

In this embodiment, the device 19 (FIG. 2) is an optocoupler. The optocoupler 19 comprises a photodiode 191 connected between the terminal 1408 of the module 14 and the terminal 2144 at the reference potential GND2. The optocoupler 19 further comprises a bipolar transistor 192, connected between the terminal 1205 and the terminal 12064, the base of which receives light emitted by the photodiode 191. The optocoupler 19 operates by linear control. In other words, a variation of the command signal of the converter 12 supplied by the module 14 to the photodiode 191 causes a corresponding variation of a signal supplied by the transistor 192 to the control terminal 1205 of the converter.

The module 14 comprises a control circuit (ctrl) 1410 configured to implement the method(s) described in connection with FIGS. 2 and 4 to 7. More particularly, the module 14 comprises comparators 1411, two comparators 1411 being shown in FIG. 8, configured to implement, in the described methods, the comparisons of the signals representative of the operation of the converter 12 with the corresponding thresholds. The circuit 1410 then determines, as a function of the output signals of the comparators 1411, whether or not the module 14 should transmit an activation signal of the device 16. As an example, the circuit 1410 is a microcontroller, a processor associated with an instruction memory, a finite state machine circuit and/or a dedicated circuit (“ASIC—Application Specific Integrated Circuit”) configured to implement the methods described in connection with FIGS. 3 to 7, in particular steps 302, 304 and 306 of these methods.

In this embodiment, the circuit 1410 is also configured to control the converter 12, and more particularly, to supply the converter 12 with a command signal representative of a difference between the value of the voltage Vsrc and a setpoint value of this voltage Vsrc. Thus, the module 14 comprises an error amplifier 1412 supplying a signal representative of this difference, from which the command signal of the converter 12 is determined.

Several ways of detecting a malfunction of the interface 214, and more particularly of its converter 12, are described in connection with FIGS. 3 to 7. Such a malfunction can also be detected:
by comparing the slope of the voltage Vsrc with respect to a maximum slope beyond which the converter 12 is considered to be defective;
by comparing a direct voltage internal to the converter, for example the voltage Vaux in FIG. 8, with one or more thresholds, for example a voltage beyond which the converter is considered to be defective; and/or
by comparing the current supplied by the converter 12 to a threshold beyond which the converter 12 is considered to be defective, this threshold for example being representative of a maximum value of the delivered current irrespective of the selected predefined power, a minimum value of the delivered current irrespective of the selected predefined power, a minimum value and/or a maximum value of the delivered current, determined by the selected predefined power. As an example, a measurement of the current circulating in the winding, or inductance, 12081 of the primary is representative of the current supplied by the converter 12, the transformation ratio of the transformer 1208 determining the link between the current in the inductance 12081 and the current supplied by the converter 12.

One skilled in the art is able, from the functional indications given above, to implement these other methods of detecting a malfunction of the converter 12, in particular to provide additional comparators and additional thresholds to implement the corresponding comparisons, in particular by modifying the module 14 accordingly.

Furthermore, although the case has been described where the module 14 transmits the activation signal of the device 16, this activation signal can also be supplied by a command module or circuit arranged on the side of the primary of the converter 12 of FIG. 8. For example, such a module can be arranged in a circuit 1211 so as to observe the variations of the voltage Vaux and transmit an activation signal of the device 16 when the voltage Vaux, or variations of the voltage Vaux, exceed a corresponding threshold beyond which the converter 12 is considered to be defective.

One skilled in the art is also able to adapt the described embodiments to the case where the voltage Vsource is a DC voltage by eliminating the rectifier bridge 1206, to the case where the device 16 is implemented otherwise than with a fuse 161, and/or to the case where the devices 19 and 20 are not optocouplers.

Various embodiments and variants have been described. Those skilled in the art will understand that certain features of these embodiments can be combined and other variants will readily occur to those skilled in the art. In particular, although embodiments of methods have been described that are implemented by the interface 214 in the case where the device 200 and the load 400 are adapted to the USB-PD technology, the embodiments described in connection with FIGS. 5 to 7 adapt to the case where the source 200 and the load 400 implement the USB-C technology, without the USB-PD function, considering that there is only a single predefined power.

Finally, the practical implementation of the embodiments and variants described herein is within the capabilities of those skilled in the art based on the functional description provided hereinabove. In particular, one skilled in the art is able to determine the values of the maximum temperature Tmax, the maximum voltage Vmax, the minimum voltage Vmin and/or threshold voltages Vth, as well as the thresholds representative of these values, from the functional indications given above and the targeted application. One skilled in the art is also able to design the module 14 as a function of the method(s) of FIGS. 3 to 7 that the interface 214 implements.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
comparing at least one signal representative of an operation of a voltage converter to at least one threshold, the voltage converter being a converter for a Universal Serial Bus Type-C (USB-C) interface coupled between a supply source and a USB-C connector, the USB-C connector being coupleable to a load supplied by the USB-C connector;
sending, by a control circuit of the USB-C interface, an activation signal based on the comparing, the activation signal being operative to control electrical isolation between the supply source and the voltage converter; and
irreversibly electrically isolating, by a disconnection device coupled between the supply source and the voltage converter, the voltage converter from the supply source in response to receiving the activation signal.

2. The method according to claim 1, comprising:
supplying, by the voltage converter, a first voltage based on a second voltage supplied by the supply source, the first voltage being a direct current (DC) voltage.

3. The method according to claim 2, wherein the signal representative of the operation of the voltage converter is at least one of: a first signal representative of a temperature of the USB-C interface, a second signal representative of the first voltage, or a third signal representative of an internal voltage of the voltage converter.

4. The method according to claim 3, wherein the signal representative of the operation of the voltage converter is the first signal representative of the temperature of the USB-C interface, and wherein:
comparing the at least one signal representative of the operation of the voltage converter to the at least one threshold includes comparing the temperature of the USB-C interface to a maximum temperature beyond which the voltage converter is considered to be defective; and
sending the activation signal based on the comparison includes sending the activation signal when the temperature of the USB-C interface is above the maximum temperature.

5. The method according to claim 3, wherein the signal representative of the operation of the voltage converter is the second signal representative of the first voltage, and wherein:
comparing the at least one signal representative of the operation of the voltage converter to the at least one threshold includes comparing the first voltage to a maximum voltage beyond which the voltage converter is considered to be defective; and
sending the activation signal based on the comparison includes sending the activation signal when the first voltage is above the maximum voltage.

6. The method according to claim 3, wherein the control circuit controls the voltage converter to supply the first voltage at a setpoint value selected from a plurality of predefined setpoint values.

7. The method according to claim 6, wherein the signal representative of the operation of the voltage converter is the second signal representative of the first voltage and the setpoint value is set to a smallest predefined setpoint value of the plurality of predefined setpoint values, and wherein:
comparing the at least one signal representative of the operation of the voltage converter to the at least one threshold includes comparing the first voltage to a minimum voltage below which the voltage converter is considered to be defective; and
sending the activation signal based on the comparison includes sending the activation signal when the first voltage is below the minimum voltage.

8. The method according to claim 6, comprising:
selecting the plurality of predefined setpoint values successively, and wherein:
comparing the at least one signal representative of the operation of the voltage converter to the at least one threshold includes comparing, for each successively-selected predefined setpoint value of the plurality of predefined setpoint values, the first voltage with a threshold voltage determined based on the successively-selected setpoint value; and
sending the activation signal based on the comparison includes sending the activation signal when the first voltage is above the threshold voltage.

9. The method according to claim 8, wherein comparing, for each successively-selected predefined setpoint value of the plurality of predefined setpoint values, the first voltage with the threshold is performed when a switch of the USB-C interface is open, wherein the switch of the USB-C interface is operative to couple the voltage converter to the USB-C connector.

10. The method according to claim 3, wherein the first signal is supplied by a temperature sensor of the USB-C interface.

11. The method according to claim 2, wherein the voltage converter is a switched-mode power supply converter having a buck-boost type, and wherein the voltage converter includes a galvanic isolation between first terminals of the voltage converter configured to receive the second voltage and second terminals of the voltage converter configured to supply the first voltage.

12. The method according to claim 1, wherein the USB-C interface includes at least one comparator configured to perform the comparison.

13. The method according to claim 1, wherein the USB-C interface includes a galvanic isolation device configured to cause the disconnection device to irreversibly electrically isolate the voltage converter from the supply source by circulating a current in a heating device of the disconnection device to cause an opening of a fuse of the disconnection device.

14. The method according to claim 1, wherein the irreversibly electrically isolating the voltage converter from the supply source includes decoupling the voltage converter from the supply source and preventing recoupling of the voltage converter to the supply source without part replacement.

15. A Universal Serial Bus Type-C (USB-C) supply interface, comprising:
a voltage converter operable to be coupled between a supply source and a USB-C connector, the USB-C connector being operable to be coupled to a load and supply power to the load;
a comparator configured to compare at least one signal representative of an operation of the voltage converter to at least one threshold;
a control circuit configured to send an activation signal based on the comparing, the activation signal being operative to control electrical isolation between the supply source and the voltage converter; and
a disconnection device configured to irreversibly electrically isolate the voltage converter from the supply source in response to receiving the activation signal.

16. The USB-C supply interface according to claim 15, wherein the voltage converter is configured to receive a first voltage from the supply source and supply a second voltage based on the first voltage.

17. The USB-C supply interface according to claim 16, the signal representative of the operation of the voltage converter is at least one of: a first signal representative of a temperature of the USB-C interface, a second signal representative of the first voltage, or a third signal representative of an internal voltage of the voltage converter.

18. The USB-C supply interface according to claim 15, comprising:
a galvanic isolation device configured to:
receive the activation signal from the control circuit; and
circulate a current in a heating device of the disconnection device to cause an opening of a fuse of the disconnection device.

19. A system, comprising:
a Universal Serial Bus Type-C (USB-C) connector operable to be coupled to a load and supply power to the load; and
a USB-C supply interface, comprising:
a voltage converter coupled between a supply source and the USB-C connector;
a comparator configured to compare at least one signal representative of an operation of the voltage converter to at least one threshold;
a control circuit configured to send an activation signal based on the comparing, the activation signal being operative to control electrical isolation between the supply source and the voltage converter; and
a disconnection device configured to irreversibly electrically isolate the voltage converter from the supply source in response to receiving the activation signal.

20. The system according to claim 19, wherein the disconnection device is configured to irreversibly electrically isolate the voltage converter from the supply source by decoupling the voltage converter from the supply source and preventing recoupling of the voltage converter to the supply source without part replacement.
